(19) United States
(12) Patent Application Publication
(10) Pub. No.: US 2014/0308960 A1
(43) Pub. Date: Oct. 16, 2014

(54) Network to Terminal Signaling for Control of Interfrequency Measurements

(71) Applicant: Nokia Solutions and Networks Oy, Espoo (FI)

(72) Inventors: Karol Drazynski, Wroclaw (PL); Guillaume Decarreau, Beijing (CN)

(21) Appl. No.: 14/357,377

(22) PCT Filed: Nov. 1, 2012
(86) PCT No.: PCT/EP2012/071652

§ 371 Date: May 9, 2014

(30) Foreign Application Priority Data
Nov. 3, 2011 (EP) PCT/EP2011/069373

(51) Int. Cl. H04W 36/00; H04W 88/02; H04W 88/06; H04W 24/10

(52) U.S. Cl. CPC H04W 36/0061; H04W 24/10; H04W 88/02; H04W 88/06
USPC 455/437; 455/550.1; 455/552.1

(57) ABSTRACT

The application relates inter-frequency measurements on cells that are on a frequency different to the active frequency. Network (RNC) signals (RRC: Measurement Configuration Message) to the UE the information by which the UE to can distinguish cells on a non-serving frequency with regard to whether measurements are to be reported for them or whether they can be connected to. This information is in particular in the form of a PSC split.

Some embodiments of the present invention relate to a method and apparatus and in particular but not exclusively to a method and apparatus useful for cell measurement reporting.

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3^{rd} Generation Partnership Project (3GPP). The various development stages of the 3GPP LTE specifications are referred to as releases. A further development of the LTE is referred to as LTE-Advanced (LTE-A).

It has been proposed to install relatively low-power base stations which may be referred to as “femto-cells” or Home NodeB (HNB) or home evolved node Bs (HeNB). Such low power base stations may be user deployed cellular base stations offering higher capacity for a given area as compared to macro cells. This is because the low power base stations use smaller cell sizes and may have more effective reuse of frequency.

Femto-cells may have different access modes: closed, hybrid and open. If the femto-cell has an open mode, the cell is freely available for user equipment. If the femto-cell has a closed subscriber list, this means that only certain user equipment are permitted to use the femto-cell. A hybrid femto-cell has characteristics of both an open and closed femto cell.

According to a first aspect, there is provided a method comprising: receiving information, from which information one or more cells for which one or more measurements are to be reported can be determined; causing, responsive to said information, one or more cells on a different frequency to an active frequency and for which one or more measurements are to be reported to be distinguished from one or more cells on said different frequency for which no measurements are to be reported; and causing a report to be sent for said one or more cells on said different frequency for which measurements are to be reported.

According to another aspect, there is provided a method comprising: receiving information indicating a connection with an active cell is to be released, a different frequency to an active frequency of said active cell and/or a different radio access technology to that of said active cell, and one or more cells on said different frequency and/or different radio access technology to which a user equipment is not to connect can be determined; releasing said connection with said active cell; and finding a new cell on said different frequency and/or different radio access technology, rejecting any cell on said different frequency and/or different radio access technology to which said user equipment is not to connect.

According to another aspect, there is provided an apparatus comprising: at least one processor and at least one memory including computer program code, wherein the at least one memory and computer program code are configured to, with the at least one processor, cause the apparatus to: cause, responsive to received information, one or more cells on a different frequency to an active frequency and for which one or more measurements are to be reported to be distinguished from one or more cells on said different frequency for which no measurements are to be reported; and cause a report to be sent for said one or more cells on said different frequency for which measurements are to be reported.

According to another aspect, there is provided an apparatus comprising: at least one processor and at least one memory including computer program code, wherein the at least one memory and computer program code are configured to, with the at least one processor, cause the apparatus to: receive information indicating a connection with an active cell is to be released, a different frequency to an active frequency of said active cell and/or a different radio access technology to that of said active cell, and one or more cells on said different frequency and/or different radio access technology to which a user equipment is not to connect can be determined; release said connection with said active cell; and find a new cell on said different frequency and/or different radio access technology, rejecting any cell on said different frequency and/or different radio access technology to which said user equipment is not to connect.

Some embodiments will now be described, by way of example only, with reference to the following examples and accompanying drawings in which:

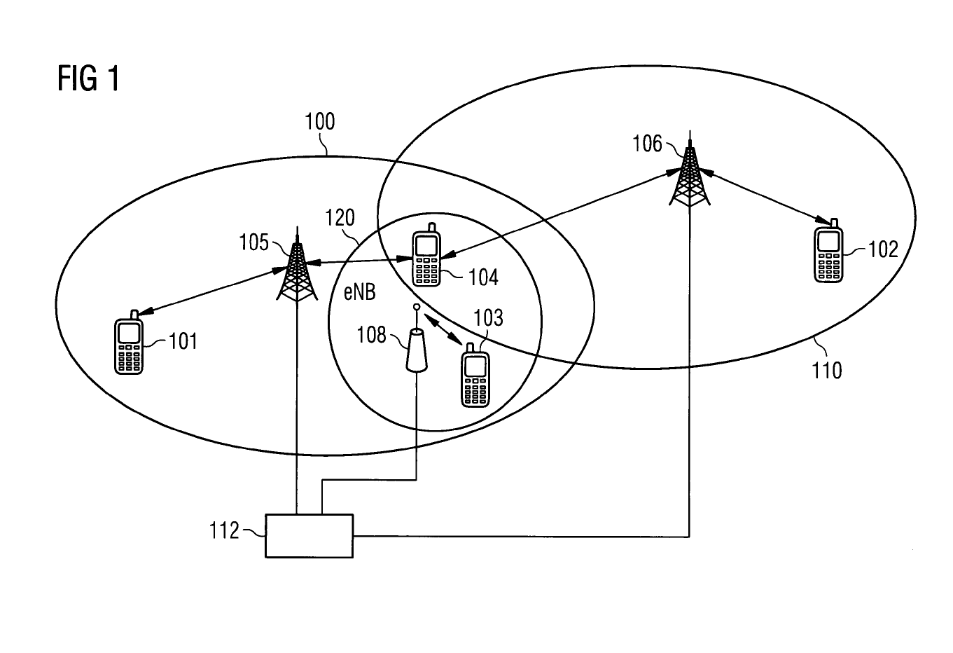

FIG. 1 shows a schematic diagram of a network according to some embodiments;

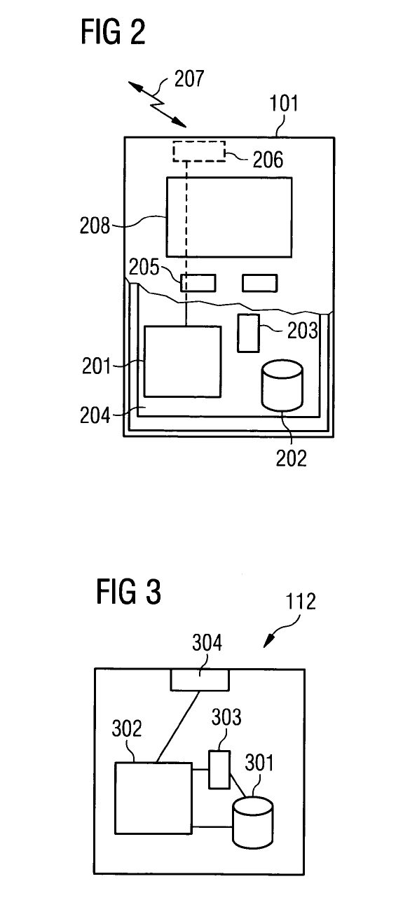

FIG. 2 shows a schematic diagram of a mobile communication device according to some embodiments;

FIG. 3 shows a schematic diagram of a control apparatus according to some embodiments;

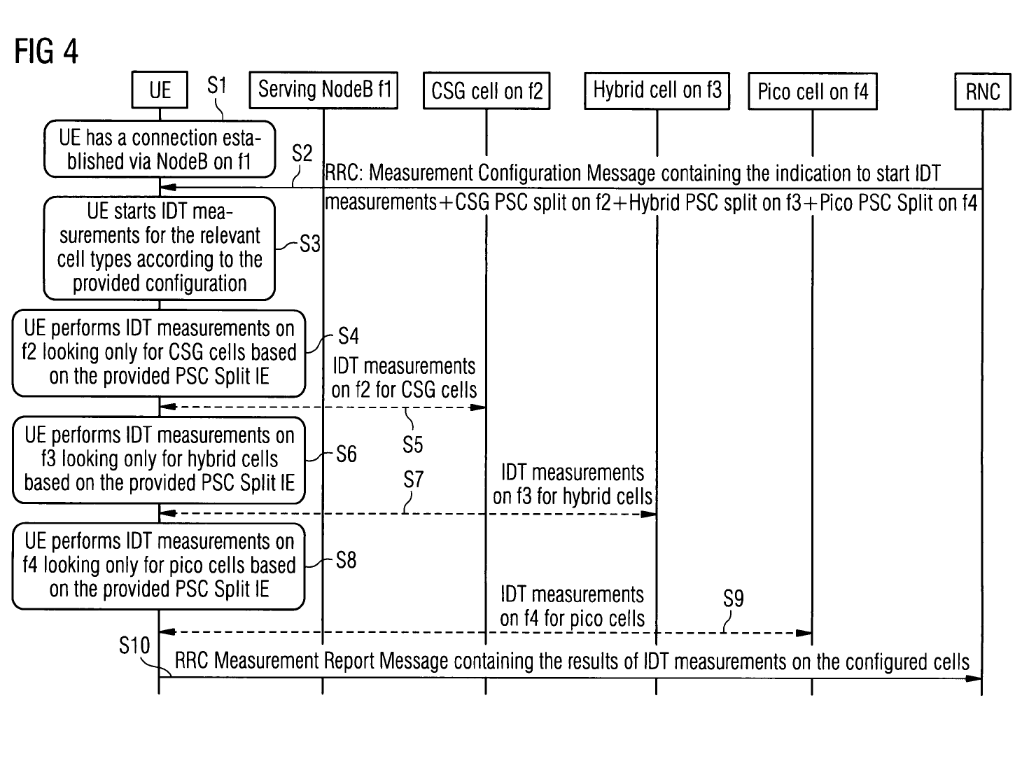

FIG. 4 shows a first signalling flow in an embodiment;

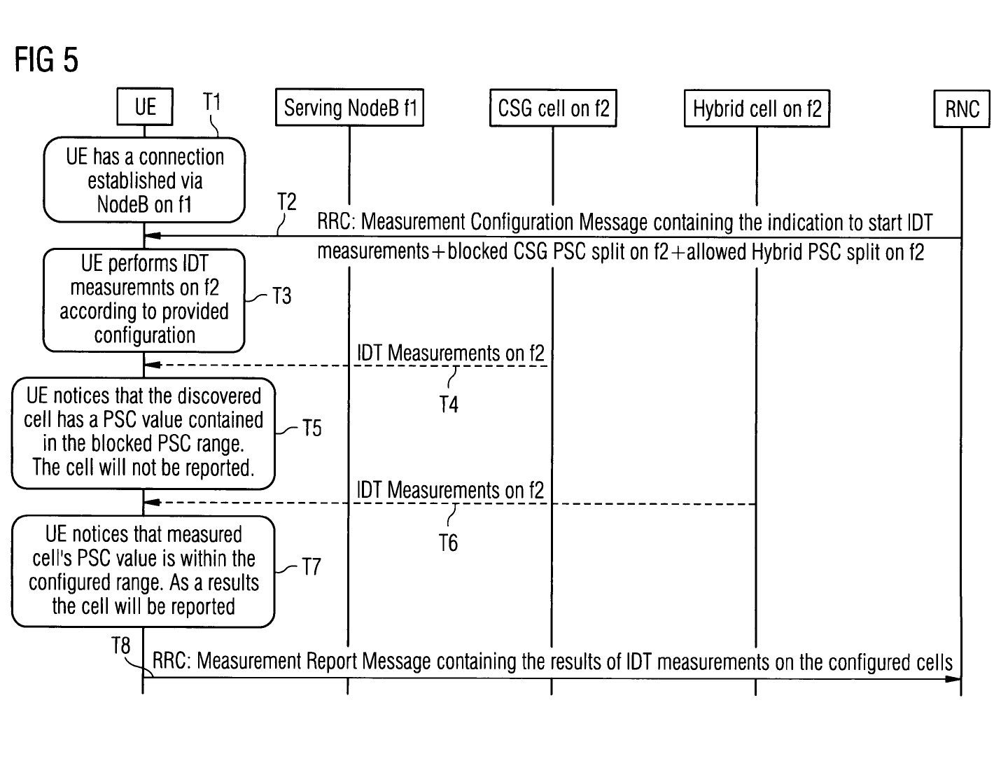

FIG. 5 shows a second signalling flow; and

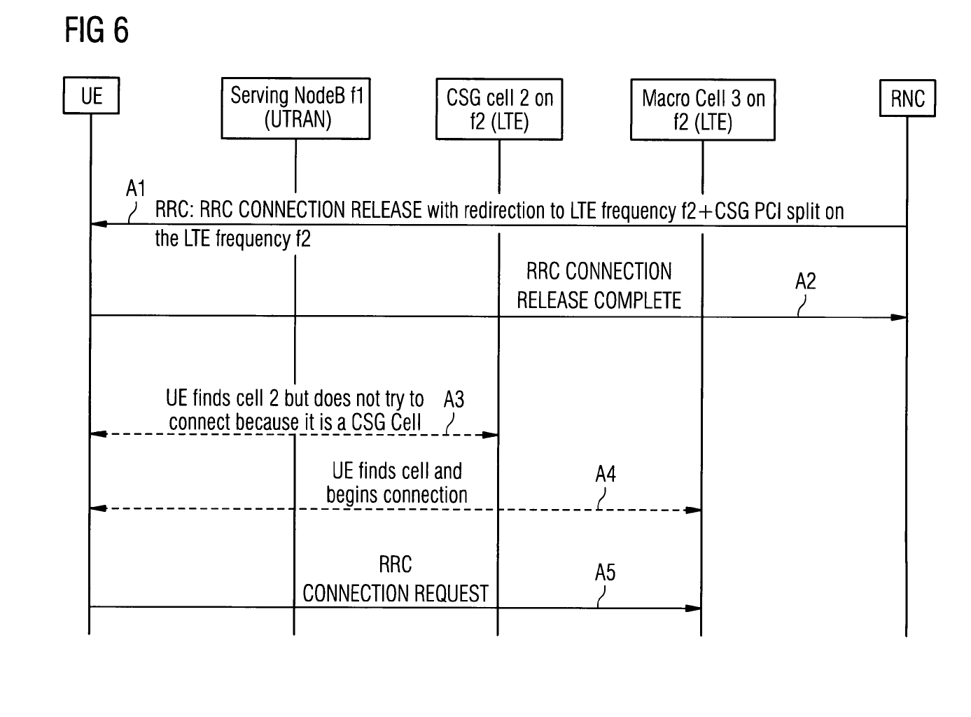

FIG. 6 shows a third signalling flow.

In the following certain exemplifying embodiments are explained with reference to a wireless or mobile communication system serving mobile communication devices. Before explaining in detail the exemplifying embodiments, certain general principles of a wireless communication system, access systems thereof, and mobile communication devices are briefly explained with reference to FIGS. 1 to 3 to assist in understanding the technology underlying the described examples.

A mobile communication device or user equipment 101, 102, 103, 104 is typically provided wireless access via at least one base station or similar wireless transmitter and/or receiver node of an access system. In FIG. 1 three neighbouring and overlapping access systems or radio service areas 100, 110 and 120 are shown being provided by base stations 105, 106, and 108.

However, it is noted that instead of three access systems, any number of access systems can be provided in a communication system. An access system can be provided by a cell of a cellular system or another system enabling a communication device to access a communication system. A base station site 105, 106, 108 can provide one or more cells. A base station can also provide a plurality of sectors, for example three radio sectors, each sector providing a cell or a subarea of a cell. All sectors within a cell can be served by the same base station. A radio link within a sector can be identified by a single logical identification belonging to that sector. Thus a base station can provide one or more radio service areas. Each mobile communication device 101, 102, 103, 104, and base station 105, 106, and 108 may have one or more radio channels open at the same time and may send signals to and/or receive signals from more than one source.

Base stations 105, 106, 108 may be controlled by a radio network controller RNC 112 so as to enable operation thereof and management of mobile communication devices 101, 102, 103, 104 in communication with the base stations 105, 106, 108. The function of the RNC may be distributed between a plurality of entities. Although not shown in FIG. 1 in some embodiments, each base station 105, 106 and 108 can have at least part of the RNC function.

The cell borders or edges are schematically shown for illustration purposes only in FIG. 1. It shall be understood that the sizes and shapes of the cells or other radio service areas may vary considerably from the similarly sized omni-directional shapes of FIG. 1.

In particular, FIG. 1 depicts two wide area base stations 105, 106, which can be macro-NBs (node B) 105, 106. The macro-NBs 105, 106 transmit and receive data over the entire coverage of the cells 100 and 110 respectively. FIG. 1 also shows a smaller base station or access point 108. The coverage of the smaller base station 108 may generally be smaller than the coverage of the wide area base stations 105, 106. The coverage provided by the smaller node 108 overlap with the coverage provided by the macro-NBs 105, 106. In some embodiments, the smaller node can be pico NB or a femto NB. A femto node B may be connected to a HNodeB Gateway which in turn is connected to RNC.

In some embodiments there may be a relatively large number of femto cells and/or pico cells near a user equipment although only one has been has been shown in FIG. 1 for illustrative purposes.

The communication devices 101, 102, 103, 104 can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

Non-limiting examples of appropriate access nodes are a base station of a cellular system, for example what is known as NodeB (NB) in the vocabulary of the 3GPP specifications. The LTE employs a mobile architecture known as the Evolved Universal Terrestrial Radio Access Network (E-UTRAN). Base stations of such systems are known as evolved Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the user devices. Other examples of radio access system include those provided by base stations of systems that are based on technologies such as wireless local area network (WLAN) and/or WiMax (Worldwide Interoperability for Microwave Access).

The communication devices will now be described in more detail in reference to FIG. 2. FIG. 2 shows a schematic, partially sectioned view of a communication device 101 that a user can use for communication. The communication device may be a mobile communication device. A communication device is often referred to as user equipment (UE) or terminal. An appropriate communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. A user may also be provided broadcast or multicast data. Non-limiting examples of the content include downloads, television and radio programs, videos, advertisements, various alerts and other information.

The user equipment 101 may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

The user equipment is also typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. Among the components 203, there is a measurement unit which is adapted to evaluate received measurement requests, to perform the measurements according to the available information, which includes preparing measurements, performing measurements eg., on cells or carriers or frequencies, evaluating measured signals, preparing measurement results, transmitting measurement report.

The user may control the operation of the user equipment by means of a suitable user interface such as a key pad 205, voice commands, touch sensitive screen or pad, combinations thereof or the like. A display 208, a speaker and a microphone can be also provided. Furthermore, a user equipment may comprise appropriate connectors (either wired or wireless) to other devices and/or for connecting external accessories, for example hands-free equipment, thereto.

FIG. 3 shows an example of the RNC 112. The RNC 112 comprises at least one memory 301, at least one data processing unit 302, 303 and an input/output interface 304. Via the interface the RNC can be coupled a plurality of base stations. The RNC 112 can be configured to execute an appropriate software code to provide control functions.

Heterogeneous networks (HetNet) have been proposed. A heterogeneous network has a macro cellular network which may be overlaid with one or more micro, pico and/or femto cells. The femto cells may be home femto cells which may be subject to unplanned deployment. Efficient interference management schemes are therefore desirable for the optimisation of HetNet cases.

Embodiments may be used in LTE, WCDMA systems or any other suitable systems.

Neighbour cell lists (NCL) include cells to which a user equipment potentially could attach and which a user equipment in connected mode is measuring and connecting to. These lists are limited in current 3GPP standards to have a fixed number of entries. Currently the number of entries for the serving frequency is 32 and 32 for other frequencies and RATs. NCLs will include information associated with cells on the same frequency as the one or more active cells to which a user equipment is currently attached.

Embodiments may be used with detected set reporting (DSR) for an inter-frequency scenario which is sometimes referred to as inter-frequency detected set measurements for UMTS. This enables the user equipment to perform inter-frequency measurements on cells outside the NCL.

As mentioned previously, some cells may have different access modes. These access modes may be closed, hybrid and/or open. Typically, femto-cells may have two or more of these access modes. In some embodiments, pico and/or micro cells may have two or more of these access modes.

A proposal has been made for closed subscriber group (CSG) cell measurements for inter-frequency detected sets. It has been suggested that an indicator be added to a measurement configuration message (MCM) to configure whether cells in the CSG mode and/or hybrid mode should be considered for inter-frequency detected set measurements.

If a user equipment is enabled to report inter-frequency CSG and/or hybrid cells, these may be added to a virtual active set. The quality of these cells may be reported in a measurement report together with the other types of cells.

However, there may be a problem with this in some scenarios. A user equipment may not know which of the cells located on the non-serving frequency are CSG or hybrid cells.

A network deploying CSG or hybrid cells can broadcast a system information block. The system information block (SIB) may, in the 3GPP standard be SIB3 or SIB11bis block. In the SIB, a CSG PSC (primary scrambling code) split range may be provided. The PSC information allows the user equipment to identify cells. The PSC split information can indicate a list or range of PSCs assigned to cells operating in the frequency. The PSC split information which is broadcast may, for example in some embodiments be valid for 24 hours on the PLMN and UARFCN (UMTS absolute radio frequency channel number) on which it was received. However, currently this only applies to IDLE mode and non CELL_DCH state reselections and is therefore not currently applicable to connected mode (CELL_DCH). CELL_DCH is a RRC Connected UE state where the terminal is assigned a dedicated (DCH) channel. This implies that the terminal performs handovers and measurements as ordered by the network.

Thus, if a user equipment has initially camped on carrier frequency number 1 and has acquired the PSC split information for this carrier, when the UE goes to the connected mode and performs inter-frequency detected set measurements on non-serving frequencies, the UE will not know which PSC values represent CSG and/or hybrid cells. Accordingly, the proposed inter-frequency detected set measurements may not be effective in the discovery of small cells.

From a different perspective, an operator may like to exclude certain types of cells, such as CSG and/or hybrid cells from it being discovered and reported by a particular user equipment. This may be because the particular user equipment does not have access rights to those CSG and/or hybrid cells. However, with the current inter-frequency detected set measurements proposal, the inter-frequency detected set measurements will be performed on a given non-serving carrier and the user equipment will not have any means to distinguish CSG and/or hybrid cells. In the case of a large number of CSG and/or hybrid cells to which a user equipment cannot attach, the number of cells reported by the user equipment may be high. This may lead to the user equipment reporting on cells to which the user equipment cannot attach and this may prevent the report of those cells which are actually available for mobility.

If the user equipment needs to handover, the message sent to the user equipment in UTRAN will not contain explicit LTE cells but only a frequency. The message sent may be, for example, the RRC (radio resource control) connection release message. However, as some of the cells are closed CSG cells, this may slow the handover or cell selection in the target LTE frequency because the user equipment would have to try another cell. In other words, UE could first try to select one of the CSG cells and the user equipment would only have an indication that the user equipment cannot be handed over to that CSG cell when the user equipment attempts handover. This uses unnecessary resources and/or slows the handover procedure.

In some embodiments, information on PSC split ranges for different types of cells on non-serving frequencies may be provided. The information may be provided in one or more information elements. The information element or information may be provided in any suitable message. The message may be a measurement control message which permits CSG/hybrid/pico/micro inter-frequency detected set measurements. The PSC split ranges may refer to different types of cells such as CSG cells, hybrid cells, pico cells or CSG cells shared by other operators on their relevant carriers.

Accordingly, the user equipment is configured to perform inter-frequency detected set measurements to discover, dependent on their configuration, CSG, hybrid and/or pico/micro cells on non-serving frequencies. This may also permit a user equipment to discover femto-cells shared by operators where the PSC and UARFSN range is different from the user equipment's own network. In this case, the PLMN may be the same. In some embodiments, it is possible to prevent inter-frequency detected set measurements UE measurements being performed on particular types of cell based on their PSC number.

The information provided to the user equipment may comprise the PSC values for cells which should not be reported and measured during inter-frequency detected set measurements. This information may be defined in terms of those values which should not be used or those values which can be used. This information can be used to prevent a user equipment from reporting CSG and/or hybrid cells from a non-serving carrier if the user equipment does not have access rights for those cells.

In some embodiments, the PSC split information may be provided for one or more different frequencies during handover or a redirection order.

Reference is now made to FIG. 4.

In the arrangement of FIG. 4, a user equipment is provided in a network and is served by a serving node B on a first frequency f1. In the neighbourhood is a CSG cell on a second frequency f2. A third frequency f3 is provided by a hybrid cell. A pico cell is provided on a fourth frequency f4. These cells are neighbouring cells. The RNC is configured to control each of these cells or at least have information for those cells which are not directly controlled by itself but which maybe is controlled by another RNC.

In the first step S1, the user equipment has a connection established via the serving node B on frequency f1. The serving node B will provide the connection means between the user equipment and RNC when a connection has been established with the user equipment.

Responsive to the establishment of the connection, the RNC will send a message, in step S2 to the user equipment. This message will be sent via the serving node B on the first (active/serving) frequency. In this example, the message is a radio resource control message. This message may be a measurement configuration message which contains the indication to start inter-frequency detected set measurements.

In some embodiments, the information which is sent by the RNC contains PSC ranges at which the UE should look while performing inter-frequency detected set measurements. In some embodiments, the information which is sent by the RNC contains PSC ranges at which the UE should not look while performing inter-frequency detected set measurements. In another embodiment the RNC may sent information to the UE containing PSC ranges (values) on which the UE should and should not perform inter-frequency detected set measurements. The RNC is able to configure the user equipment to perform inter-frequency detected set measurements according to the relevant PSC split information to discover or omit particular types of cells.

As mentioned previously, inter-frequency detected set measurements are the measurements carried out by the user equipment on frequencies different to that used by the serving node B. In other words, the user equipment is instructed by the inter-frequency detected set measurements message to carry out measurements on frequencies other than the first frequency f1. This message will also include information indicating which types of cells (denoted by PSC range) e.g. CSG cells on the second frequency f2 can be measured, which types of cells (denoted by PSC range) e.g. hybrid cells on the frequency f3 can be measured and which types of cells (denoted by PSC range) e.g. pico cells on the fourth frequency f4 can be measured.

As mentioned previously, this information can positively identify those cells which can be measured or indicate those cells which should not be measured. In some embodiments, information on the associated frequency may be provided. The information may be provided in the form of the PSC number.: In some embodiments the UE is given the non-serving frequency on which the UE should perform inter-frequency detected set measurements and the PSC values which it should/should not measure. Which types of cells (CSG/hybrid/pico/etc) are given a particular CSG range may be implementation specific and may be different for each of the used frequencies.

In the third step S3, the user equipment will start the inter-frequency detected set measurements for the relevant cell types in dependence on the received information from the RNC.

In step S4, the user equipment is configured to start performing inter-frequency detected set measurements on the second frequency f2 looking at the CSG cells which are allowed based on the received information from the RNC.

In step S5, the measurements are performed and then will be stored in the user equipment.

In step S6, the user equipment is configured to start performing inter-frequency detected set measurements on the third frequency f3, looking at the relevant hybrid cells. This is again based on the information received from the RNC. Step S7 schematically illustrates the measurement process and storing of results.

Likewise, in step S8 the user equipment performs inter-frequency detected set measurements on the fourth frequency f41 looking at the permitted pico cells based on the information received from the RNC. Again, step S9 schematically shows the measurements performed by the user equipment and storage of results by the user equipment.

In step S10, the user equipment will sent via the serving node B to the RNC, an RRC measurement report message containing the results of the inter-frequency detected set measurements on the configured cells.

The step monitoring of the different cells can of course take place in a different order to that shown in FIG. 4.

Depending on the capability of the user equipment, the user equipment may be able to carry out measurements on two or more of the frequencies at the same time.

The message which is sent via the serving node B to the RNC may be any other suitable message.

Information may be sent in some embodiments after each frequency measurement has been made or every time a cell is measured.

FIG. 5 illustrates a second scenario. In this example, the serving cell is on frequency f1, the CSG cell is on a second frequency f2 and a hybrid cell is also on the frequency f2. In the scenario of FIG. 5, the user equipment is prevented by the RNC from performing on inter-frequency detected set measurements for certain types of cells on the non-serving frequency based on the provided PSC split.

Step T1 is the same as step S1 described in FIG. 4 and will not be described again.

Step T2 is similar to S2. However, in this message, the RNC instructs the user equipment to start the inter-frequency detected set measurements. The RNC indicates in this example that the user equipment is blocked from performing measurements on the CSG cell on f2 but is permitted to carry out measurements on the hybrid cell on the frequency f2.

In step T3, the user equipment is configured to perform an inter-frequency detected set measurement on the second frequency in accordance with the provided configuration on the CSG cell.

The measurements made are schematically represented by step T4.

However, in step T5, the user equipment determines that the discovered cell has a PSC value contained in the blocked PSC range. The cell will therefore not be reported.

In step T6, inter-frequency detected set measurements on the second frequency f2 are carried out in respect of the hybrid cell.

In step T7, the user equipment notices that the measured cells PSC value is within the configured range. As a result, the cell will be reported.

Step T8 is similar to step S10 of FIG. 4 and will not be described again.

By stating which cells should or should not be measured and reported during inter-frequency detected set measurements, the RNC is able to customise offloading the user equipment. This allows the network operator greater control over the network. For example, some user equipments without access rights to a CSG or hybrid cell may instead be offloaded to a pico or, for example, open access femto-cell.

Embodiments may allow the network operator to control the distribution of user equipment. For example, it may be advantageous to keep the user equipment attached to closed or hybrid femto-cells where the user equipment is permitted access to those cells and to keep the open access cells available for other user equipment.

Embodiments may be used where there are more and more small cells deployed on different carriers. The NCL is relatively short and it may not be possible to list all of those cells in such a NCL.

Embodiments may allow the control of the network to offload terminals to, for example, smaller cells more quickly.

Reference is made to FIG. 6 which a further signalling flow.

In this example, the user equipment is connected to a serving cell on a first frequency f1 (UTRAN Cell). A LTE CSG cell on a second frequency f2 and a macro LTE cell also on the second frequency f2 is provided. In this embodiment, a user equipment may be handed over or redirected from one radio access technology RAT to a different radio access technology. This is referred to inter RAT reselection.

In step A1, the radio network controller sends via the serving node B a release connection message to the user equipment. This may be a radio resource control message. The user equipment is instructed to change to the second frequency f2. The message is also provided with CSG's PCI split information relating to the second frequency. PCI is the similar to PSC but for an LTE Cell. It is the Physical Cell ID of the cell. There may be information indication that a change to a different radio access technology is required or that indication may be derived from any other suitable information. The information may indicate which cells the user equipment can connect and/or not connect. Alternatively the information may be such that the UE is able to determine which cells the UE can connect and/or not connect.

In step A2, the radio resource control connection release is complete.

In step A3 the user equipment attempts to find a cell on the frequency f2. The user equipment finds the CSG cell on the second frequency f2. However, because of the information received from the RNC, the user equipment knows that it is not permitted to connect to that cell.

In step A4, the user equipment finds the macro cell on the second frequency f2.

Based on the information which the user equipment has received in step A1, the user equipment determines that it is permitted to make a connection to that macro cell and accordingly begins the connection.

In step A5, the user equipment will make an RRC connection request to the macro cell.

Some methods may provide measurement parameters from a network node to the user equipment. The network node may be a RNC or any other suitable node or nodes.

The measurement parameters may comprise PSC split information on a further frequency. The measurement parameters may take a different form. The measurement parameters may indicate which one or more cells or which one or more cell types are to be monitored. The information may include implicitly or explicitly the frequency to be monitored.

The user equipment may use the information to control which cells are reported and/or on which measurements are performed.

The user equipment may be configured to send one or more measurement reports including cells which are selected in dependence on the information received from, for example, the network node.

Some embodiments may allow the user equipment to detect different types of cells and perform or exclude measurements for specified cell types or cells.

Embodiments may allow a network operator to control measurement reporting in the network.

Some embodiments may permit the focusing of user equipment to certain cell types.

Some embodiments may improve network reliability by improving mobility decisions in the connected mode of the user equipment. This may be because cells which are not available to the user equipment can be excluded from the handover decision where handover would in any case fail. Delay of handover may be undesirable as this may risk connection loss and/or degrade the quality.

Some embodiments may permit the disadvantage of the current limitation of 32 neighbour cells listed in the NCL to be avoided. This may be avoided in some embodiments by allowing detected set reporting for other frequencies.

In some embodiments, notification of the PSC split applicable in the other frequency to the user equipment may improve measurement performance by causing the user equipment to focus on permitted cells. In some embodiments this may be achieved by causing the user equipment to focus on cells operating with the indicated PSC values and exclude extensive measurements on cells which are not of interest for mobility decisions because, for example, the user equipment would not be permitted access to those cells.

Embodiments may be used in any suitable situation for example, be used where there are a number of smaller cells, such as femto, macro and/or pico cells.

Embodiments have been described as using PSC split information to control which cells are monitored/not monitored and/or handed over to/not handed over to. It should be appreciated that this information is one example and in alternative embodiments, different information may be provided.

The information may be dependent on the standard used with some embodiments.

Some embodiments have been described in the context of preventing user equipment from monitoring CSG and/or hybrid cells. In some embodiments, this mechanism may be used by the network operator to assert control over which cells are used by a user equipment. This may be for network planning issues or any other suitable issue. Accordingly, the cells which the user equipment is stopped from monitoring may be open access cells, in some embodiments.

It should be appreciated that the FIGS. 4 to 6 not only show the signal flow but also illustrate one or more method steps performed by the user equipment, base stations and RNC.

Various different embodiments have been described. It should be appreciated that one or more embodiments may be used at least partially in combination.

Various different methods have been shown. It should be appreciated that in some embodiments one or more of the method steps may be combined into a single step. In some embodiments, one or more of the method steps may be changed in terms of order. In some embodiments, one or more steps may be omitted. In some embodiments, one or more additional steps may be included.

One or more of the steps of any of the methods may be implemented using a respective arrangement. The respective arrangement may comprise circuitry and/or may be performed by one or more processors run computer code. One or more arrangements may be provided by common circuitry and/or the same one or more processors as used by another arrangement. Where one or more processors are provided, these processors may operate in conjunction with one or more memories.

The required data processing apparatus and functions of a base station apparatus, user equipment and RNC may be provided by means of one or more data processors. These may perform one or more of the method steps of a respective method.

The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip.

Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of embodiments may be implemented in hardware, while other aspects may be implemented in firmware or software which may be executed by a controller, microprocessor or other computing device, although embodiments are not limited thereto. While various aspects of the embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Some embodiments may be implemented by computer software executable by one or more data processors in conjunction with one or more memories of a base station, UE or RNC.

One or more steps of a method of an embodiment may be performed when computer executable instructions are run on one or more processors.

Further in this regard it should be noted that any blocks of the logic flow as in the Figures may represent program steps, or interconnected logic circuits, blocks and functions, or a combination of program steps and logic circuits, blocks and functions.

The software or computer executable instructions may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method comprising:
receiving information, from which information one or more cells for which one or more measurements are to be reported can be determined;
causing, responsive to said information, one or more cells on a different frequency to an active frequency and for which one or more measurements are to be reported to be distinguished from one or more cells on said different frequency for which no measurements are to be reported; and
causing a report to be sent for said one or more cells on said different frequency for which measurements are to be reported.

2. A method as claimed in claim 1, wherein said information comprises primary scrambling code split information.

3. A method as claimed in claim 1, wherein said information comprises an indication to perform inter frequency detected set measurements.

4. A method as claimed in claim 1, wherein said information identifies the cells for which measurements are to be reported.

5. A method as claimed in claim 1, wherein said information identifies the cells for which no measurements are to be reported.

6. A method as claimed in claim 1, wherein said information is received in one or more information elements.

7. A method as claimed in claim 1, wherein said information comprises information indicating the type of cells which are to be reported or the type of cells which are not to be reported.

8. A method as claimed in claim 1, wherein said information comprises frequency information for the at least one cell for which measurements are to be reported.

9. A method as claimed in claim 1, wherein said information is received in a measurement control message.

10. A method as claimed in claim 1, wherein said report comprises a measurement report message.

11. A method as claimed in claim 1, wherein at least one of said cells for which no measurements are to be reported comprise at least one of a closed subscriber group cell, a hybrid cell and a pico cell.

12. A method comprising:
receiving information indicating a connection with an active cell is to be released, a different frequency to an active frequency of said active cell and/or a different radio access technology to that of said active cell, and one or more cells on said different frequency and/or different radio access technology to which a user equipment is not to connect;
releasing said connection with said active cell; and
finding a new cell on said different frequency and/or different radio access technology, rejecting any cell on said different frequency and/or different radio access technology to which said user equipment is not to connect.

13. A method as claimed in claim 12, wherein said information about one or more cells on said different frequency and/or different radio access technology to which said user equipment is not to connect comprises primary scrambling code information.

14. A user equipment configured to perform the method of claim 1.

15. A computer program product comprising computer executable program code which when run on a processor performs the method claim 1.

16. An apparatus comprising: at least one processor and at least one memory including computer program code, wherein the at least one memory and computer program code are configured to, with the at least one processor, cause the apparatus to:
cause, responsive to received information, one or more cells on a different frequency to an active frequency and for which one or more measurements are to be reported to be distinguished from one or more cells on said different frequency for which no measurements are to be reported; and
cause a report to be sent for said one or more cells on said different frequency for which measurements are to be reported.

17. Apparatus as claimed in claim 16, wherein said information comprises primary scrambling code split information.

18. Apparatus as claimed in claim 16, wherein said information comprises an indication to perform inter frequency detected set measurements.

19. Apparatus as claimed in claim 16, wherein said information identifies the cells for which measurements are to be reported.

20. Apparatus as claimed in claim 16, wherein said information identifies the cells for which no measurements are to be reported.

21. Apparatus as claimed in claim 16, wherein said information is received in one or more information elements.

22. Apparatus as claimed in claim 16, wherein said information comprises information indicating the type of cells which are to be reported or the type of cells which are not to be reported.

23. Apparatus as claimed in claim 16, wherein said information comprises frequency information for the at least one cell for which measurements are to be reported.

24. Apparatus as claimed in claim 16, wherein said apparatus is configured to receive said information in a measurement control message.

25. Apparatus as claimed in claim 16, wherein said report comprises a measurement report message.

26. Apparatus as claimed in claim 16, wherein at least one of said cells for which no measurements are to be reported comprise at least one of a closed subscriber group cell, a hybrid cell and a pico cell.

27. An apparatus comprising: at least one processor and at least one memory including computer program code, wherein the at least one memory and computer program code are configured to, with the at least one processor, cause the apparatus to:
receive information indicating a connection with an active cell is to be released, a different frequency to an active frequency of said active cell and/or a different radio access technology to that of said active cell, and one or more cells on said different frequency and/or different radio access technology to which a user equipment is not to connect;
release said connection with said active cell; and
find a new cell on said different frequency and/or different radio access technology, rejecting any cell on said different frequency and/or different radio access technology to which said user equipment is not to connect.

28. Apparatus as claimed in claim 27, wherein said information about one or more cells on said different frequency and/or different radio access technology to which said user equipment is not to connect comprises primary scrambling code information.

29. A user equipment comprising apparatus as claimed in claim 16.
